(19) United States
(12) Patent Application Publication
(10) Pub. No.: US 2005/0093185 A1
(43) Pub. Date: May 5, 2005

(54) Method of manufacturing optical recording medium

(75) Inventor: Tsuyoshi Komaki, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/977,246

(22) Filed: Nov. 1, 2004

(30) Foreign Application Priority Data
Nov. 5, 2003 (JP) 2003-375604

(51) Int. Cl. B29D 11/00

(52) U.S. Cl. 264/1.33; 264/2.1; 264/2.7

(57) ABSTRACT

A method for manufacturing a multilayer recording type optical recording medium with favorable recording/reading characteristics is provided. After an energy beam curable resin is pressurized by a light transmitting stamper so as to be extended over the entire surface of the substrate, the substrate and the light transmitting stamper are rotated so as to expel part of the energy beam curable resin to the outside in a radial direction by centrifugal force, thereby forming the energy beam curable resin at a predetermined thickness.

### BACKGROUND OF THE INVENTION

1. Field of the Invention

The present invention relates to a method for manufacturing an optical recording medium including a plurality of information layers spaced with a spacer layer, which are formed on either one of or both surfaces of a substrate.

2. Description of the Related Art

Recently, optical recording media such as a CD (Compact Disc) and a DVD (Digital Versatile Disc) are rapidly spreading as information recording media. The optical recording medium is generally standardized to have an outer diameter of 120 mm and a thickness of 1.2 mm. In the case of the DVD, a laser beam having a shorter wavelength than that for the CD is used as irradiation light. In addition, a numerical aperture of a lens of the DVD for the irradiation light is set larger than that for the CD. As a result, the DVD is capable of recording and reproducing a larger amount of information at a higher density than the CD.

On the other hand, information recording and reproduction accuracy is more likely to lower as the wavelength of irradiation light becomes shorter and the numerical aperture of a lens becomes larger. This is because coma aberration occurs due to inclination and warp of a disc. Thus, the DVD includes a light transmitting layer having a half thickness of that of the CD, that is, 0.6 mm so as to ensure a margin for the inclination and the warp of the disc to maintain the information recording/reproduction accuracy.

Since the light transmitting layer at a thickness of 0.6 mm alone does not offer sufficient stiffness and strength, the DVD has such a structure that a pair of substrates, each having a thickness of 0.6 mm, are bonded to each other so that the information recording faces inside. As a result, the DVD has a thickness of 1.2 mm, which is equal to that of the CD, to ensure almost the same stiffness and strength as those of the CD.

In order to realize the recording of a larger amount of information at a higher density, the wavelength of irradiation light is further reduced while the numerical aperture of a lens is further increased. In response thereto, an optical recording medium including a light transmitting layer at a further reduced thickness has attracted attention (for example, see Japanese Patent Laid-Open Publication No. 2003-85836).

In order to standardize the specifications, a blue-violet laser beam having a wavelength of approximately 405 nm is used as irradiation light while the numerical aperture is set to 0.85. In correspondence with the laser beam and the numerical aperture, an optical recording medium including a light transmitting layer at a thickness of approximately 100 μm is now increasingly in widespread use. It is proposed that a track pitch of a minute convexo-concave pattern (pitch of concave and convex portions) of an information layer is set to approximately 320 nm.

The optical recording medium can also be formed as a dual-layer recording medium by forming a spacer layer on an information layer formed on either one of or both the surfaces of a substrate having a convexo-concave pattern such as a pit and a groove and then forming another information layer on the spacer layer. In order to standardize the specifications for the dual-layer recording medium, it is suggested to set a thickness of the spacer layer to approximately 25 μm and a thickness of the light transmitting layer to approximately 75 μm (total thickness of approximately 100 μm). In order to keep good information recording/reproduction accuracy, a variation in the total thickness of two layers, i.e., a spacer layer and a light transmitting layer, is required to be ±2 μm; namely, a difference between the minimum total thickness and the maximum total thickness of the two layers is required to be 4 μm or less. Incidentally, the dual-layer recording medium may have two or more spacer layers to form three or more information layers.

As a technique of forming a plurality of information layers in a convexo-concave pattern composed of pits or grooves, the following technique is known (for example, see Japanese Patent Laid-Open Publication No. 2003-91887). According to the technique, a convexo-concave pattern is first formed on a substrate by injection molding, and an information layer is formed by sputtering or the like in accordance with the convexo-concave pattern. Next, an energy beam curable resin in a flowing state is supplied to the vicinity of the center of the information layer. The substrate and a light transmitting stamper for transferring the concave-convex pattern onto the energy beam curable resin are rotated with the light transmitting stamper being abutted on the energy beam curable resin. In this manner, the energy beam curable resin is extended on the entire surface of the substrate by centrifugal force so as to be formed in a predetermined shape. Next, the extended energy beam curable resin is irradiated with an energy beam such as an ultraviolet ray or an electron beam through the light transmitting stamper so as to be cured. Then, after the light transmitting stamper is removed, another information layer is formed by sputtering or the like in accordance with a convexo-concave pattern of the spacer layer. If three or more information layers are to be formed, the same procedure is repeated.

However, an optical recording medium including a plurality of information layers formed by the above-described technique has a disadvantage in that favorable recording/reproduction characteristics cannot be obtained.

### SUMMARY OF THE INVENTION

In view of the foregoing problems, various exemplary embodiments of this invention provide a method for manufacturing an optical recording medium, which enables the formation of a plurality of information layers with favorable recording/reproduction characteristics.

Various exemplary embodiments of the present invention attempt achieving the above object by pressurizing an energy beam curable resin with a light transmitting stamper so as to extend it over the entire surface of a substrate and then rotating the substrate and the light transmitting stamper to expel a part of the energy beam curable resin to the outside in a radial direction by centrifugal force so as to form a spacer layer at a desired thickness.

As a result of analysis of the reason why favorable recording/reproduction characteristics cannot be obtained in the case where a plurality of information layers are formed by the above-described conventional technique, the inventor found that it was due to low profile accuracy of convexo-concave patterns on both surfaces of a spacer layer. Although the reason of the low profile accuracy of convexo-concave patterns on both surfaces of the spacer layer is not exactly known, it is conceivable as follows. When a substrate and a light transmitting stamper are rotated so as to extend an energy beam curable resin, the energy beam curable resin cannot get to a deep part of a concave portion of the convexo-concave patterns of the information layer over the substrate and the light transmitting stamper because it is affected by centrifugal force. As a result, the convexo-concave pattern of the information layer over the substrate and the convexo-concave pattern of the light transmitting stamper are not accurately transferred to the spacer layer.

In order to cope with this problem, the inventor first attempted to form a spacer layer by pressurizing an energy beam curable resin with a light transmitting stamper without rotating the substrate and the light transmitting stamper. Although the convexo-concave patterns composed of pits or grooves could be successfully transferred to both the surfaces of a spacer layer, a variation in thickness of the spacer layer was increased. Accordingly, favorable recording/reproduction characteristics could not be obtained.

As a result of a further keen examination, the inventor ended up completing the present invention. Accordingly, various exemplary embodiments of this invention provide
a method for manufacturing an optical recording medium, comprising:
a spacer layer formation step of applying an energy beam curable resin onto an information layer formed over a substrate and then abutting a light transmitting stamper on the energy beam curable resin to form the energy beam curable resin in a predetermined shape;
a spacer layer curing step of radiating an energy beam through the light transmitting stamper to the energy beam curable resin so as to cure the energy beam curable resin; and
an information layer formation step of removing the light transmitting stamper and thereafter forming the other/another information layer on the spacer layer, wherein
the spacer layer formation step includes:
a pressurizing/extending step of pressurizing the energy beam curable resin by the light transmitting stamper to extend the energy beam curable resin over the entire surface of the substrate; and
a rotating/expelling step of rotating the substrate and the light transmitting stamper to expel a part of the energy beam curable resin to outside in a radial direction by centrifugal force, the pressurizing/extending step and the rotating/expelling step being carried out in this order.

Throughout this specification, the term “energy beam” is used for generically denoting, for example, electromagnetic waves such as ultraviolet rays, and electron beams, and particle beams, which have a property of curing a specific resin in a flowing state.

According to the various exemplary embodiments of the present invention, by pressurizing an energy beam curable resin with a light transmitting stamper so as to extend it, it is ensured that convexo-concave patterns composed of pits or grooves can be transferred to both surfaces of a spacer layer. Furthermore, a variation in thickness of the spacer layer can be controlled by rotating the substrate and the light transmitting stamper to form the spacer layer with a desired thickness.

### BRIEF DESCRIPTION OF THE DRAWINGS

Various exemplary embodiments of the present invention will be described in detail with reference to the accompanying drawings, wherein:

FIG. 1 is a sectional side view schematically showing a structure of an optical recording medium manufactured in an exemplary embodiment of the present invention;

FIG. 2 is a flowchart showing the outline of a manufacture process of the optical recording medium shown in FIG. 1;

FIG. 3 is a sectional side view schematically showing a structure of a substrate in the manufacture process of the optical recording medium;

FIG. 4 is a sectional side view schematically showing a state where a core member is inserted into a manufacture center hole in the substrate;

FIG. 5 is a sectional side view schematically showing a state where an energy beam curable resin is applied over the entire surface of the substrate;

FIG. 6 is a sectional side view schematically showing a state where a light transmitting stamper is brought close to the substrate;

FIG. 7 is a sectional side view schematically showing a pressurizing/extending step of the energy beam curable resin;

FIG. 8 is a sectional side view schematically showing a rotating/expelling step of the energy beam curable resin;

FIG. 9 is a sectional side view schematically showing a curing step of the spacer layer;

FIG. 10 is a sectional side view schematically showing a state where the light transmitting stamper and the core member are removed from the spacer layer;

FIG. 11 is a sectional side view schematically showing a process of extending a light transmitting layer over the spacer layer;

FIG. 12 is a sectional side view schematically showing a state where the light transmitting layer is extended to have a predetermined thickness;

FIG. 13 is a sectional side view schematically showing a curing step of the light transmitting layer;

FIG. 14 is a sectional side view schematically showing a step of forming the center hole; and

FIG. 15 is a graph showing noise values in optical recording mediums according to Working Example of the present invention and Comparative Examples 1 and 2.

### DETAILED DESCRIPTION OF THE PREFERRED EMBODIMENT

Various exemplary embodiments of this invention will be hereinafter described in detail with reference to the drawings.

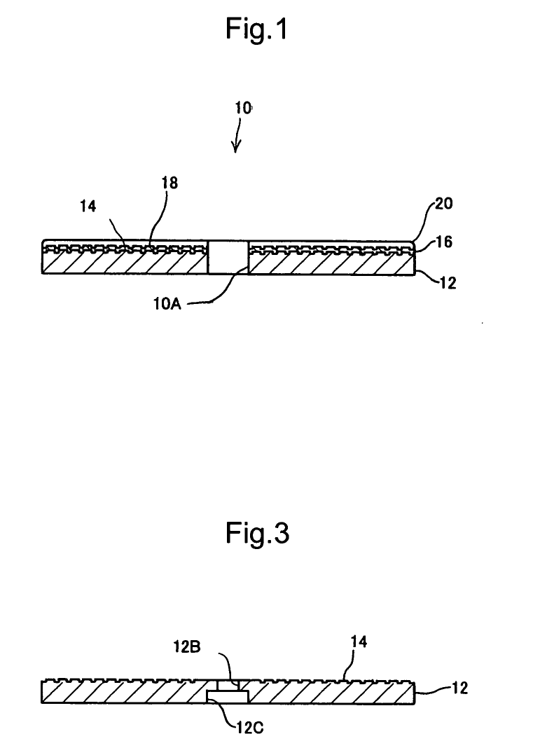

This exemplary embodiment is characteristic in a method for forming a spacer layer 16 in an optical recording medium 10 as shown in FIG. 1. For understanding of this exemplary embodiment, the structure of the optical recording medium 10 will first be described in a brief manner.

The optical recording medium 10 has a disc-like shape having an outer diameter of approximately 120 mm and a thickness of approximately 1.2 mm. The optical recording medium 10 is a single-sided dual-layer recording optical disc including a first information layer 14, the spacer layer 16, a second information layer 18, and a light transmitting layer 20 formed over one face of a substrate 12 in this order. A center hole 10A having an inner diameter of approximately 15 mm is formed through the optical recording medium 10.

The substrate 12 is made of a resin such as polycarbonate, acrylic, and epoxy, and has a thickness of about 1.1 mm. A convexo-concave pattern composed of pits for information transfer or grooves for tracking servo is formed on a surface of the substrate 12 on the side of the first information layer 14.

The terms “pit” and “groove” are generally used for designating a fine concave portion serving for information transfer. Throughout this specification, however, the terms “pit” and “groove” are used even for designating a convex portion serving for information transfer for convenience as long as it serves for information transfer.

The first information layer 14 is formed in a convexo-concave patterned shape by copying the convexo-concave pattern of the substrate 12. Since the first information layer 14 is remarkably thin as compared with the substrate 12, the spacer layer 16, and the light transmitting layer 20, it is illustrated with a line drawing. The first information layer 14 is composed of a single functional layer or a plurality of functional layers depending on its use. For example, if the optical recording medium 10 is a ROM (Read Only Memory) type, the first information layer 14 is composed of a reflective layer made of Al, Ag, Au, or the like. If the optical recording medium 10 is an RW (Re-Writable) type, the first information layer 14 is composed of a layer such as a phase-change material layer, a photomagnetic material layer, or a dielectric material layer in addition to the reflective layer. In the case of an R (Recordable) type, the first information layer 14 is composed of a layer such as a phase-change material layer or an organic dye layer in addition to the reflective layer.

The spacer layer 16 has a thickness of approximately 25 μm and is made of a material, for example, mainly composed of an energy beam curable resin having light transmittance such as an ultraviolet curable acrylic resin and an ultraviolet curable epoxy resin.

A surface of the spacer layer 16 on the first information layer 14 side has a convexo-concave pattern by copying the convexo-concave patterned shape of the first information layer 14. A convexo-concave pattern composed of pits and grooves is also formed on the other surface of the spacer layer 16 on the second information layer 18 side.

The second information layer 18 is formed in accordance with the convexo-concave pattern of the spacer layer 16, and is composed of a single functional layer or a plurality of functional layers based on its use as in the case of the first information layer 14. Since, similarly to the first information layer 14, the second information layer 18 is also remarkably thin as compared with the substrate 12, the spacer layer 16, and the light transmitting layer 20, it is illustrated with a line drawing.

The light transmitting layer 20 has a thickness of about 75 μm and is made of an energy beam curable resin having light transmittance such as an ultraviolet curable acrylic resin and an ultraviolet curable epoxy resin as in the case of the spacer layer 16. A face of the light transmitting layer 20 on the second information layer 18 side has a convexo-concave patterned shape by copying the convexo-concave pattern of the second information layer 18, whereas a surface of the light transmitting layer 20 (the other face of the light transmitting layer 20, which is opposite to the second information layer 18) is flat.

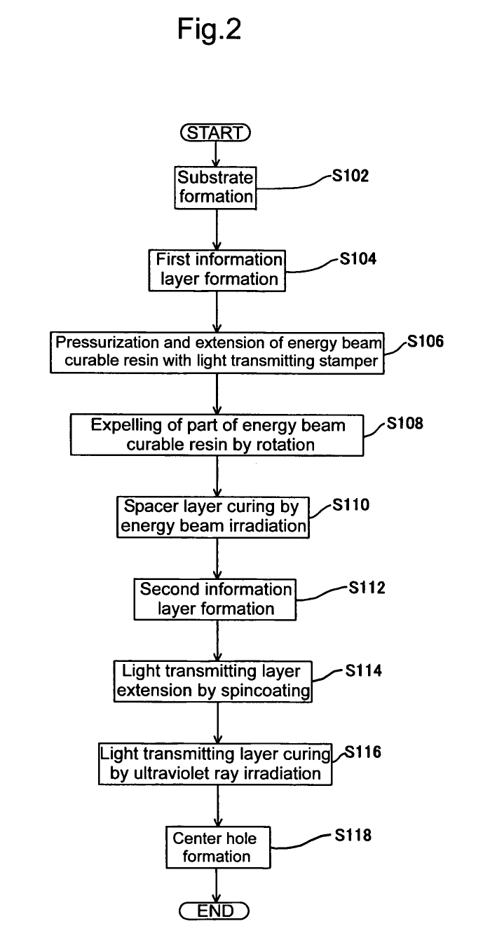

Next, a method for fabricating the optical recording medium 10 will be described with reference to a flowchart shown in FIG. 2 and the like.

First, the disc-shaped substrate 12 having an outer diameter of about 120 mm and a thickness of about 1.1 mm as shown in FIG. 3 is formed by injection molding (S102). At this step, a convexo-concave pattern composed of pits and grooves is formed on one face of the substrate 12. Moreover, in the injection molding, a circular concave portion 12C having an equal inner diameter to that of the center hole 10A is formed on a face of the substrate 12, which is opposite to the face on which the convexo-concave pattern is formed. Furthermore, a manufacture hole 12B having a smaller inner diameter than that of the center hole 10A is formed through the substrate 12 in the injection molding. The manufacture hole 12B may be formed through the substrate 12 by using a tool or the like after the injection molding.

For storage, delivery, or the like, a plurality of the substrate 12 are normally piled up. Since a plurality of substrates 12 can be easily piled up in an aligned manner by simply inserting a round-bar shaped guide or the like through the manufacture holes 12B of the respective substrates 12, the storage, the delivery, and the like can be easily carried out, contributing to improvement of production efficiency.

Next, the first information layer 14 is formed on the face of the substrate 12, which carries the convexo-concave pattern, by sputtering, vapor deposition or the like (S104). The first information layer 14 is formed in a convexo-concave patterned shape by copying the convexo-concave pattern of the substrate 12.

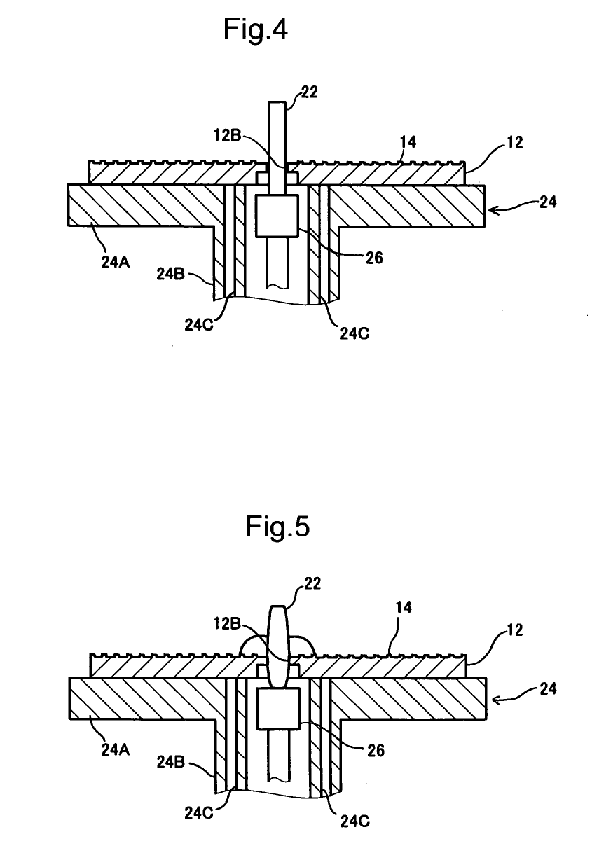

Next, as shown in FIG. 4, while a core member 22 is being inserted into the manufacture hole 12B of the substrate 12, the substrate 12 is placed horizontally on a rotating table 24 so that the first information layer 14 is oriented upward.

The rotating table 24 has such a structure that a shaft part 24B downwardly projects beyond a disc-shaped table part 24A that is horizontally placed. In the shaft portion 24B, an air hole 24C in communication with an upper surface of the table portion 24A is formed. The shaft portion 24B is engaged with a rotation driving mechanism not shown in the drawing. A negative-pressure feeder (not shown) is connected to the air hole 24C.

The core member 22 has such a round bar shape that its outer diameter in a normal state is slightly smaller than the inner diameter of the manufacture hole 12B. Such a shape allows the core member 22 to be fitted into the manufacture hole 12B with play. The core member 22 is made of a silicone resin, a fluorocarbon resin, an acrylic resin, an olefin resin, or a mixture thereof to have elasticity. In addition, the core member 22 has a hollow structure (the illustration herein omitted). At its lower end, the interior of the core member 22 is in communication with air supply means 26. By air supply to the interior, the core member 22 is expanded to have an increased outer diameter so as to be brought into close contact with an inner circumference of the manufacture hole 12B.

First, as shown in FIG. 5, the core member 22 is expanded by the air supply means 26 so as to come into close contact with the inner circumference of the manufacture hole 12B. A negative pressure is fed to the upper surface of the table part 24A so as to suck the substrate 12 to fix it onto the rotating table 24. A predetermined amount of an energy beam curable resin in a flowing state is supplied to the vicinity of the center of the substrate 12. Since the core member 22 is in close contact with the inner circumference of the manufacture hole 12B, the energy beam curable resin does not enter the space between the core member 22 and the substrate 12.

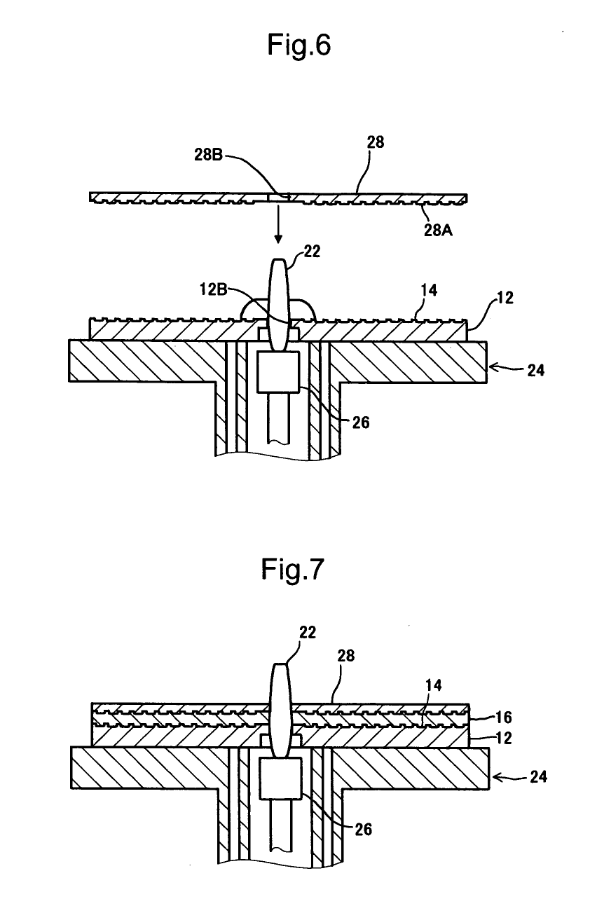

Next, as shown in FIG. 6, the light transmitting stamper 28 is brought close to the substrate 12 without rotating the substrate 12 and the light transmitting stamper 28.

The light transmitting stamper 28, which has an approximately disc-like shape, is made of a light transmitting material such as acrylic, olefin, or glass. One of the surfaces of the light transmitting stamper 28 serves as a transfer face 28A for transferring pits or grooves. Moreover, the light transmitting stamper 28 has a through hole 28B in the vicinity of the center. The through hole 28B has an inner diameter which allows the core member 22 to be fitted therein with play.

The light transmitting stamper 28 is abutted on the energy beam curable resin supplied to the vicinity of the center of the substrate 12 as shown in FIG. 7 and then is pressurized so as to be brought closer to the substrate 12 at a distance of about several hundreds of μm therefrom. As a result, concave portions of the first information layer 14 and concave portions of the transfer face 28A of the light transmitting stamper 28 are filled with the energy beam curable resin while the energy beam curable resin is extended over the entire surface of the substrate 12. As a result, the convexo-concave patterns composed of pits or grooves are transferred to both the surfaces of the energy beam curable resin (the spacer layer 16) (S106). At this time, since the substrate 12 and the light transmitting stamper 28 are not rotated so that centrifugal force does not act on the energy beam curable resin, it is ensured that the concave portions of the first information layer 14 and the light transmitting stamper 28 are filled with the energy beam curable resin. Specifically, the convexo-concave patterns composed of pits or grooves are transferred to both the surfaces of the energy beam curable resin (the spacer layer 16) with high accuracy.

If the light transmitting stamper 28 is brought closer to the substrate 12 at a speed exceeding 80 μm/sec, the pressure becomes excessive. As a result, the energy beam curable resin is likely to enter the space between the substrate 12 and the core member 22. If the light transmitting stamper 28 is brought closer to the substrate 12 at a speed exceeding 70 μm/sec, air bubbles are likely to be included in the energy beam curable resin. On the other hand, if the light transmitting stamper 28 is brought closer to the substrate 12 at a speed lower than 15 μm/sec, there arises a productivity problem.

Therefore, it is preferred that the substrate 12 and the light transmitting stamper 28 be brought closer to each other at a speed within the range of 15 to 70 μm/sec. If the substrate 12 and the light transmitting stamper 28 are brought closer to each other at a speed within the range of 15 to 60 μm/sec, it can be further ensured that the enter of the energy beam curable resin between the substrate 12 and the core member 22 and the inclusion of air bubbles in the energy beam curable resin are prevented.

If the energy beam curable resin is extended to have a thickness smaller than 125 μm corresponding to a thickness five times that of the spacer layer 16 at the pressurizing/extending steps (S106), a thickness profile is more affected by a degree of parallelization between the substrate 12 and the light transmitting stamper 28. Thus, it is difficult to obtain a desired thickness profile at the following rotating/expelling step (S108). On the other hand, if the energy beam curable resin is extended to have a thickness larger than 1 mm corresponding to 40 times the thickness of the spacer layer, an excessive amount of the energy beam curable resin, which is not used to form the spacer layer, becomes too large, inducing a productivity problem.

Thus, it is preferred that the energy beam curable resin is extended to have a thickness corresponding to 5 to 40 times the thickness of the spacer layer.

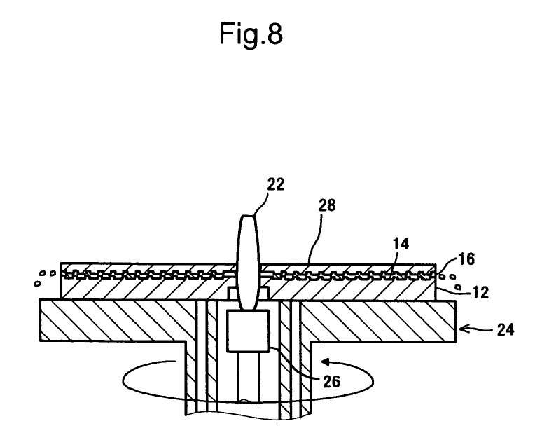

Next, as shown in FIG. 8, the rotating table 24 is rotated so as to allow the energy beam curable resin to flow to the outside in a radial direction due to centrifugal force. A partial excessive energy beam curable resin is expelled to the outside from a space between the substrate 12 and the light transmitting stamper 28 (S108). The light transmitting stamper 28 comes closer to the substrate 12 because of a negative pressure, thereby reducing the thickness of the energy beam curable resin (the spacer layer 16). At this time, since the energy beam curable resin scarcely flows in the vicinity of the surfaces of the substrate 12 and the light transmitting stamper 28, the convexo-concave patterns composed of pits or grooves transferred to the energy beam curable resin keep a good profile.

The rotation is stopped when the light transmitting stamper 28 comes at a distance of approximately 25 μm away from the substrate 12, whereby the energy beam curable resin is formed to have a thickness of approximately 25 μm. In this manner, the substrate 12 and the light transmitting stamper 28 are rotated to expel an excessive energy beam curable resin to the outside in a radial direction to regulate its thickness. As a result, a variation in thickness of the energy beam curable resin (the spacer layer 16) can be kept small.

Alternatively, a waiting step, at which the substrate and the light transmitting stamper are made to wait in a static state, may be provided between the pressurizing/extending step (S106) and the rotating/expelling step (S108). If ever the concave portions of the convexo-concave patterns of the substrate 12 and the light transmitting stamper 28 can not be perfectly filled with the energy beam curable resin at the pressurizing/extending step (S106), it can be ensured by providing the waiting step as described above that the concave portions of the convexo-concave patterns of the substrate 12 and the light transmitting stamper 28 are filled with the energy beam curable resin owing to a capillary phenomenon.

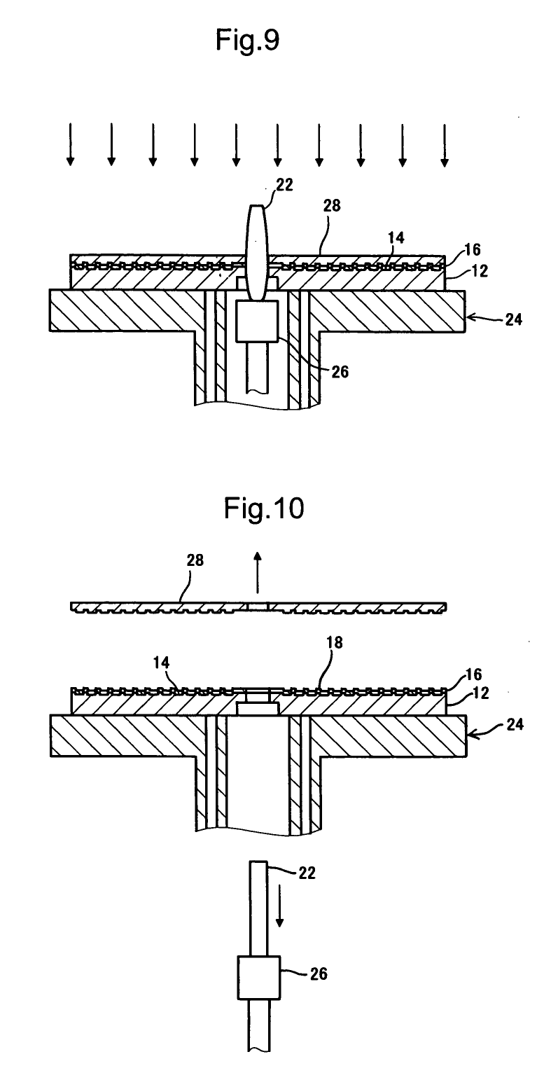

Next, as shown in FIG. 9, after the rotation of the rotating table 24 is stopped, the spacer layer 16 is uniformly irradiated with an energy beam such as an ultraviolet ray through the light transmitting stamper 28 so as to be cured (S110).

At this step, as shown in FIG. 10, the light transmitting stamper 28 is removed from the spacer layer 16. Then, the interior of the core member 22 is depressurized to be restored to a normal state from an expanded state so that the core member 22 is separated away from the substrate 12. Since the core member 22 is made of a silicone resin, a fluorocarbon resin or the like, it hardly sticks to the spacer layer 16. Accordingly, the substrate 12 can be easily separated away from the core member 22.

Furthermore, after the substrate 12, over which the spacer layer 16 is formed, is removed from the rotating table 24, the second information layer 18 is formed on the spacer layer 16 by sputtering, vapor deposition or the like (S112). The second information layer 18 is formed to have a convexo-concave patterned shape in accordance with the convexo-concave pattern of the spacer layer 16.

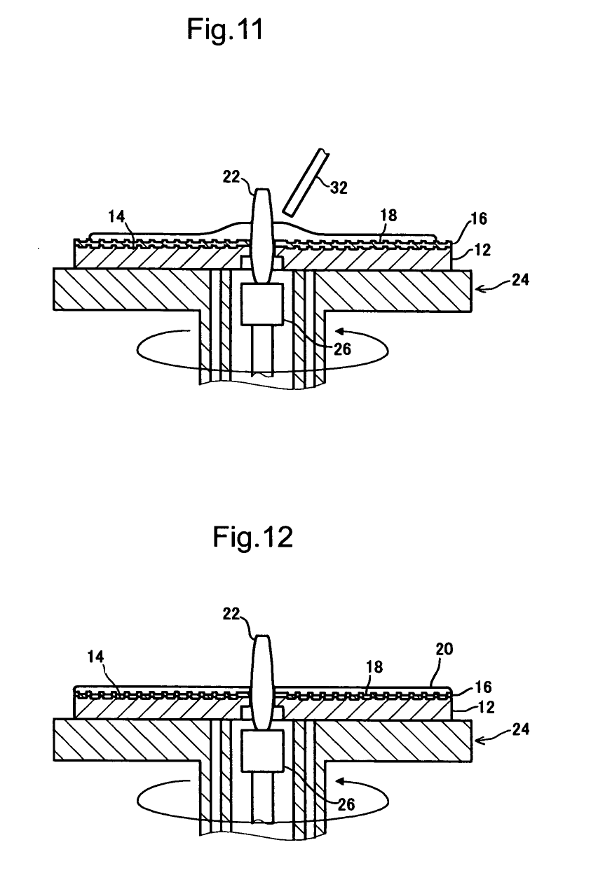

Next, the substrate 12 is held on the rotating table 24 again. After the core member 22 is brought in close contact with the inner circumference of the manufacture hole 12B, a nozzle 32 is brought closer to the vicinity of the core member 22 while the rotating table 24 is being driven to rotate as shown in FIG. 11. When a predetermined amount of the energy beam curable resin in a flowing state is supplied from the nozzle 32 onto the second information layer 18, the supplied energy beam curable resin is extended outward in a radial direction by centrifugal force.

As a result, as shown in FIG. 12, the light transmitting layer 20 is extended over the entire surface of the spacer layer 16 to have a uniform thickness of approximately 75 μm (S114).

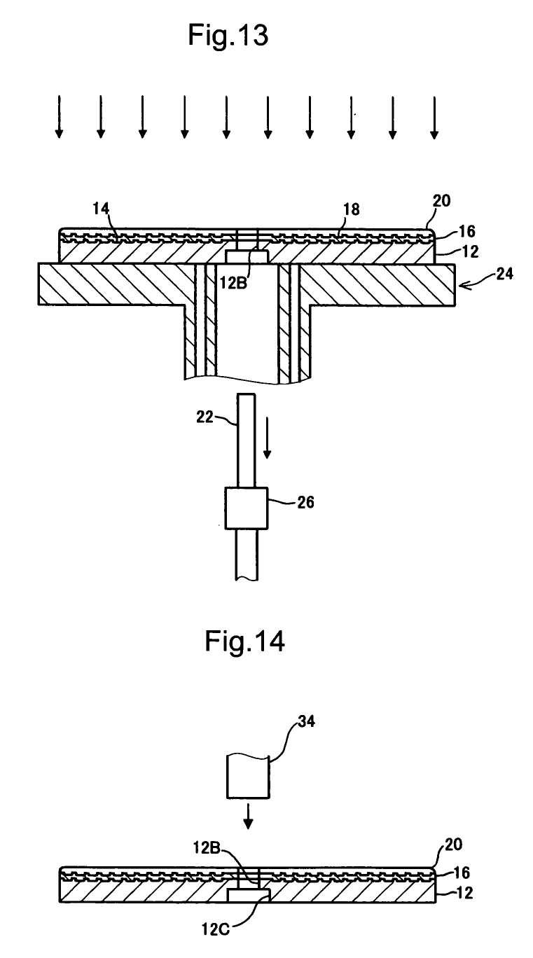

Subsequently, as shown in FIG. 13, the rotation of the rotating table 24 is stopped. The extended light transmitting layer 20 is uniformly irradiated with an energy beam such as an ultraviolet ray so as to be cured (S116).

Next, the interior of the core member 22 is depressurized to be restored to a normal state from an expanded state so that the core member 22 is separated away from the substrate 12. After the substrate 12 is removed from the rotating table 24, a jig is fitted into the fabrication hole 12B so as to position the substrate 12 (the illustration herein omitted). Thereafter, as shown in FIG. 14, a circular tool 34, which has an outer diameter equal to the inner diameter of the center hole 10A, is coaxially arranged on the substrate 12 so as to abut on and perforate through the substrate 12 in an axial direction to form the center hole 10A through the substrate 12 (S118). The circular concave portion 12C having the same inner diameter as that of the center hole 10A, which is formed in the substrate 12, facilitates the perforation. Moreover, by positioning the substrate 12 with use of the fabrication hole 12B, the amount of eccentricity of the center hole 10A can be kept small.

By the above process, the optical recording medium 10 is completed.

In this exemplary embodiment, after the energy beam curable resin is supplied to the vicinity of the center of the substrate 12, the energy beam curable resin is pressurized by the light transmitting stamper 28 so as to be extended over the entire surface of the substrate 12. However, the energy beam curable resin may be supplied to a portion that is slightly distant from the vicinity of the center of the substrate 12 and then be pressurized by the light transmitting stamper 28 as long as the energy beam curable resin can be extended over the entire surface of the substrate 12.

In this exemplary embodiment, the ultraviolet curable acrylic resin and the ultraviolet curable epoxy resin are exemplified as examples of the material of the spacer layer 16 and the light transmitting layer 20 in this exemplary embodiment, other energy beam curable resin materials having light transmittance such as an electron beam curable resin can also be used.

Moreover, in this exemplary embodiment, the substrate 12 having a circular concave portion 12C having the same inner diameter as that of the center hole 10A (i.e., having a larger inner diameter than that of the manufacture hole 12B) on its one face is formed by injection molding. Alternatively, the substrate 12 having flat surfaces on both sides may be formed by injection molding.

In this exemplary embodiment, the core member 22 is made of a silicone resin, a fluorocarbon resin, or the like to have elasticity. The core member 22 also has a round-bar shape with an outer diameter slightly smaller than the inner diameter of the fabrication hole 12B in its normal state so as to be fitted into the fabrication hole 12B with play. However, a material and a shape of the core member 22 are not particularly limited as long as the core member 22 has such a structure that it can come into close contact with the inner circumference of the fabrication hole 12B.

In this exemplary embodiment, although the optical recording medium 10 has a disc-like shape with the center hole 10A in this exemplary embodiment, the present invention is also applicable to the fabrication of an optical recording medium without any center hole.

In this exemplary embodiment, the optical recording medium 10 is dual-layer recording type including a single spacer layer and two information layers in this exemplary embodiment. However, if the present invention is applied to a multilayer recording type optical recording medium including two or more spacer layers and three or more information layers, the same effects can be obtained.

The optical recording medium 10 is described as a single-sided multilayer recording type medium capable of recording information only on one side in this exemplary embodiment. However, it is apparent that the present invention is also applicable to a double-sided multilayer recording type optical recording medium capable of recording information on both sides. For example, in the case of double-sided dual-layer recording type, a thickness of a substrate is set to approximately 1.0 mm. A spacer layer having a thickness of 25 μm and a light transmitting layer having a thickness of 75 μm are formed on each of the surfaces of the substrate, whereby an optical recording medium having a thickness of 1.2 mm can be obtained.

The convexo-concave patterns of the first information layer 14 and the second information layer 18 may be equal to each other or different from each other in accordance with the type of optical recording medium.

### WORKING EXAMPLE

As described in the above exemplary embodiment, the spacer layer 16 having a thickness of approximately 25 μm and the light transmitting layer 20 having a thickness of approximately 75 μm were formed over one face of the substrate 1 having a thickness of approximately 1.1 mm. Specifically, the first information layer 14 was formed on the substrate 12 by sputtering. Approximately 1 g of an energy beam curable resin serving as a material of the spacer layer 16 was applied onto the first information layer 14 at a thickness of approximately 2 mm. The energy beam curable resin was pressurized by the light transmitting stamper 28 while the substrate 12 and the light transmitting stamper 28 were brought closer to each other at a speed of approximately 50 μm/sec until a thickness of approximately 600 to 800 μm was obtained. Convexo-concave patterns of grooves were transferred to both surfaces of the energy beam curable resin, while the energy beam curable resin was extended over the entire surface of the substrate 12.

Each of the convexo-concave patterns on both the surfaces of the spacer layer 16 was such a spiral pattern that a track pitch was approximately 320 nm, a groove width was approximately 140 nm (a land width of approximately 180 nm), and a groove depth was approximately 18.0 nm. The groove in this working example designates a convex portion projecting toward the light transmitting layer 20 side.

As the energy beam curable resin, which was a material of the spacer layer 16, the following materials were used.
Pentaerythritol triacrylate: approximately 50 parts by weight
Hydroxypivalic acid neopentyl glycol diacrylate: approximately 50 parts by weight
1-hydroxy cyclohexyl phenyl ketone: approximately 3 parts by weight

After the energy beam curable resin was pressurized to obtain a thickness of approximately 600 to 800 μm, the substrate 12 and the light transmitting stamper 28 were made to wait in a static state for approximately five seconds. Thereafter, the substrate 12 and the light transmitting stamper 28 were rotated at a speed of rotation of approximately 4000 rpm for approximately 11 seconds so as to adjust the thickness of the energy beam curable resin to approximately 25 μm. Furthermore, the energy beam curable resin was irradiated with an ultraviolet ray to be cured, thereby forming the spacer layer 16.

The second information layer 18 was formed on the spacer layer 16 by sputtering. The light transmitting layer 14 was then formed on the second information layer 18. In this manner, ten optical recording mediums 10 were manufactured.

A total thickness of two layers, i.e., the spacer layer 16 and the light transmitting layer 20 of the optical recording mediums 10 were measured to be 101.4±2 μm. Specifically, the thickness was measured at 1140 positions at every approximately 2 mm within the range of 22 to 58 mm in a radial direction and at every approximately 6 degrees in a circumferential direction by using a thickness measuring device Core9930a (manufactured by Cores Co., Ltd.) for ten optical recording mediums 10. Then, an average value of the measured thicknesses was calculated.

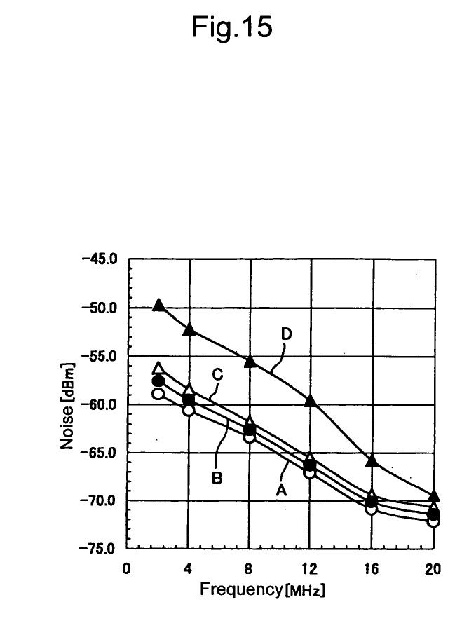

A jitter of the second information layer 18 of the each optical recording medium 10 was measured to be approximately 7.28%. A high-frequency noise of the second information layer 18 was also measured. As a result, the relation between a frequency (MHz) and a noise (dBm) was as indicated with a curve denoted by the reference symbol A in FIG. 15. A high-frequency noise of the first information layer 14 was also measured. As a result, the relation between a frequency (MHz) and a noise (dBm) was as indicated with a curve denoted by the reference symbol B in FIG. 15. For measurement of the jitter and the noises, an optical disc evaluation device DDU1000 (manufactured by Pulstec Industrial Co., Ltd.) was used.

A groove depth (height of a convex portion) formed on the spacer layer 16 on the second information layer 18 side and a groove width (width of a convex portion in the vicinity of the center in a height direction) were measured with an AFM (Atomic Force Microscope). As a result, the groove depth was approximately 17.4 nm and the groove width was approximately 176 nm. The convexo-concave pattern on the transfer face 28A of the light transmitting stamper 28 was such that the groove depth (depth of a concave portion) was approximately 18.0 nm and the groove width (width of a concave portion) was approximately 180 nm.

### Comparative Example 1

In contrast with the above-described Working Example, approximately 1 g of an energy beam curable resin serving as a material of the spacer layer 16 was applied onto the entire surface of the first information layer 14 at a thickness of approximately 2 mm. The energy beam curable resin was interposed between the substrate 12 and the light transmitting stamper 28 to be pressurized, whereby the substrate 12 and the light transmitting stamper 28 were brought closer to each other. In this way, convexo-concave patterns of grooves were transferred to both surfaces of the energy beam curable resin, while a thickness of the energy beam curable resin was obtained to be approximately 25 μm. In this case, the substrate 12 and the light transmitting stamper 28 were not rotated. Ten optical recording mediums 10 were manufactured under otherwise the same conditions as those in the above-described Working Example.

A total thickness of two layers, i.e., the spacer layer 16 and the light transmitting layer 20 of the each optical recording medium 10 was measured to be 99.4±12 μm.

A jitter of the second information layer 18 of the optical recording medium 10 was measured to be approximately 8.86%. In addition, a high-frequency noise of the second information layer 18 was also measured. As a result, the relation between a frequency (MHz) and a noise (dBm) was as indicated with a curve denoted by the reference symbol C in FIG. 15.

### Comparative Example 2

In contrast with the above-described Working Example, approximately 1 g of an energy beam curable resin serving as a material of the spacer layer 16 was applied exclusively to the vicinity of the center of the first information layer 14. After the energy beam curable resin was brought in contact with the light transmitting stamper 28, the substrate 12 and the light transmitting stamper 28 were rotated at a speed of rotation of approximately 4000 rpm for approximately eight seconds so as to form the energy beam curable resin at a thickness of approximately 25 μm. At the same time, convexo-concave patterns of grooves were transferred to both the surfaces of the energy beam curable resin. Ten optical recording mediums 10 were manufactured under otherwise the same conditions as those of the Example described above.

A total thickness of two layers, i.e., the spacer layer 16 and the light transmitting layer 20 of the each optical recording medium 10 was measured to be 101.2±2 μm.

A jitter of the second information layer 18 of the each optical recording medium 10 was measured to be approximately 11.57%. In addition, a high-frequency noise of the second information layer 18 was also measured. As a result, the relation between a frequency (MHz) and a noise (dBm) was as indicated with a curve denoted by the reference symbol D in FIG. 15.

The results of the above-described Working Example, Comparative Example 1, and Comparative Example 2 are shown in comparison in Table 1.

TABLE 1

| | | | | Light |
|---|---|---|---|---|
| | Working | Comparative | Comparative | transmitting |
| | Example | example 1 | example 2 | stamper |
| Total thickness of | 101.4 ± 2 | 99.4 ± 12 | 101.2 ± 2 | — |
| spacer layer and | | | | |
| light transmitting | | | | |
| layer (μm) | | | | |
| Jitter value (%) | 7.28 | 8.86 | 11.57 | — |
| Groove depth | 17.4 | 17.5 | 15.5 | 18.0 |
| (nm) | | | | |
| Groove width | 176 | 177 | 165 | 180 |
| (nm) | | | | |

A variation in thickness of the spacer layer 16 was good in Working Example and Comparative Example 2 because it was kept to be ±2 μm, which is equal to a target value, whereas a variation in thickness of the spacer layer 16 in Comparative Example 1 was ±12 μm, which considerably exceeds the target value. The reason for these results is believed as follows. The spacer layer 16 was formed to have a thickness of approximately 25 μm while the substrate 12 and the light transmitting stamper 28 are being rotated in Working Example and Comparative Example 2, whereas a thickness of approximately 25 μm is achieved for the spacer layer 16 only by means of pressurization without the rotation in Comparative Example 1.

Moreover, in Working Example and Comparative Example 1, the transfer accuracy of the convexo-concave pattern on the transfer face of the light transmitting stamper 28 is high, the jitter of the second information layer 18 is lower than the upper target value of 10%, and the noise of the second information layer 18 is good because it is kept to be ±2 dBm with respect to that of the first information layer 14. On the other hand, in Comparative Example 2, the transfer accuracy is low, the jitter exceeds the upper target value of 10%, and the noise is greatly larger than that of the first information layer 14. The reason of these results is believed as follows. The convexo-concave patterns of grooves are transferred to the spacer layer 16 without rotating the substrate 12 and the light transmitting stamper 28 in Working Example and Comparative Example 1. On the other hand, the convexo-concave patterns of grooves are transferred to the spacer layer 16 while the substrate 12 and the light transmitting stamper 28 are being rotated in Comparative Example 2.

Various exemplary embodiments of the present invention can be used for manufacturing a multilayer recording type optical recording medium.

1. A method for manufacturing an optical recording medium, comprising:
a spacer layer formation step of applying an energy beam curable resin onto an information layer formed over a substrate and then abutting a light transmitting stamper on the energy beam curable resin to form the energy beam curable resin in a predetermined shape;
a spacer layer curing step of radiating an energy beam through the light transmitting stamper to the energy beam curable resin so as to cure the energy beam curable resin; and
an information layer formation step of removing the light transmitting stamper and thereafter forming the other/another information layer on the spacer layer, wherein
the spacer layer formation step includes:
a pressurizing/extending step of pressurizing the energy beam curable resin by the light transmitting stamper to extend the energy beam curable resin over the entire surface of the substrate; and
a rotating/expelling step of rotating the substrate and the light transmitting stamper to expel apart of the energy beam curable resin to outside in a radial direction by centrifugal force, the pressurizing/extending step and the rotating/expelling step being carried out in this order.

2. The method for manufacturing an optical recording medium according to claim 1, wherein
the pressurizing/extending step brings the substrate and the light transmitting stamper closer to each other at a speed in the range of 15 to 70 μm/sec so as to pressurize the energy beam curable resin.

3. The method for manufacturing an optical recording medium according to claim 1, wherein
the pressurizing/extending step extends the energy beam curable resin so as to have a thickness 5 to 40 times that of the spacer layer.

4. The method for manufacturing an optical recording medium according to claim 2, wherein
the pressurizing/extending step extends the energy beam curable resin so as to have a thickness 5 to 40 times that of the spacer layer.

5. The method for manufacturing an optical recording medium according to claim 1, wherein
a waiting step of making the substrate and the light transmitting stamper to wait in a static state is provided between the pressurizing/extending step and the rotating/expelling step.

6. The method for manufacturing an optical recording medium according to claim 2, wherein
a waiting step of making the substrate and the light transmitting stamper to wait in a static state is provided between the pressurizing/extending step and the rotating/expelling step.

7. The method for manufacturing an optical recording medium according to claim 3, wherein
a waiting step of making the substrate and the light transmitting stamper to wait in a static state is provided between the pressurizing/extending step and the rotating/expelling step.

8. The method for manufacturing an optical recording medium according to claim 4, wherein
a waiting step of making the substrate and the light transmitting stamper to wait in a static state is provided between the pressurizing/extending step and the rotating/expelling step.
